(19) United States
(12) Patent Application Publication
(10) Pub. No.: US 2008/0283744 A1
(43) Pub. Date: Nov. 20, 2008

(54) Charged Particle Beam Device

(75) Inventors: Satoshi TAKADA, Hitachinaka (JP); Hiroyuki Ito, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Minato-ku (JP)

(21) Appl. No.: 12/018,898

(22) Filed: Jan. 24, 2008

(30) Foreign Application Priority Data
Jan. 25, 2007 (JP) 2007-014909

(51) Int. Cl. G21K 7/00

(52) U.S. Cl. 250/307; 250/310; 250/311

(57) ABSTRACT

A charged particle beam device of the present invention, which can correct astigmatism, off-axis aberration and out-of-focus state simultaneously at high speed, is provided with an electrostatic lens between an objective lens and a sample, which lens generates an electric field on a trajectory of a charged particle beam. The electrostatic lens is divided into a plurality of electrodes, and a voltage can be applied to the electrodes independently. By adjusting this voltage, any one of the astigmatism, the off-axis aberration and the out-of-focus state of the objective lens is corrected.

### BACKGROUND OF THE INVENTION

1. Field of the Invention

The present invention relates to a scanning charged particle beam device which irradiates an object with charged particles, and particularly relates to a technique which corrects astigmatism, off-axis aberrations, out-of-focus state and the like.

2. Description of the Related Art

Examples of scanning charged particle beam devices are scanning electron microscopes (SEM), scanning transmission electron microscopes (STEM) and ion beam machining devices. Devices using them include scanning tunnel microscopes.

The scanning electron microscopes scan samples with electron beams as probes, and detect secondary electrons generated from the samples due to the scanning. The scanning transmission electron microscopes scan samples with electron beams as probes, and detect electrons transmitted through the samples due to the scanning. The ion beam machining devices narrow down ion beams to irradiate desired positions on sample surfaces and can machine the samples. Further, the ion beam machining devices scan the sample surfaces with ion beams and detect the amount of secondary electrons generated at the time of ion collision so that shapes of the surface can be observed microscopically.

For example, focused ion beam (FIB) devices have a scanning ion microscope (SIM) function. In scanning tunnel microscopes, a sample and a probe are made to be extremely close to each other, and both of them are scanned comparatively two-dimensionally, an electric current flowing in the probe is detected so that an image is displayed based on the detected electric current.

In the charged particle beam devices, astigmatism occurs due to machining error and assembly error of optical components. For this reason, an astigmatism corrector which corrects the astigmatism is provided. In order to improve yield of secondary electrons generated from a sample, an electrostatic lens is provided in a vicinity of an objective lens, and a voltage is applied to it. Further, this applied voltage is slightly changed so that a focus of a charged particles beam can be corrected at high speed.

Japanese Patent Application Laid-Open No. 5-114378 (Patent Document 1) discloses a method for obtaining an optimum focus automatically using a focus correcting function. An exciting current of the objective lens is changed into a sawtooth shape, and an optimum exciting current is derived based on an integration value of image signals obtained at respective steps.

In the charged particle beam devices having such an optical system, the axes of the objective lens and the electrostatic lens occasionally do not align with each other. As a result, when the exciting current of the objective lens or the applied voltage of the electrostatic lens are changed in a state where the astigmatism has been corrected by the astigmatism corrector, astigmatism occurs due to off-axis. Therefore, as described in Japanese Patent Application Laid-Open No. 8-306331 (Patent Document 2), for example, a technique which changes the exciting current of the astigmatism corrector according to each changed contents of optical conditions so as to prevent the occurrence of the astigmatism is known.

As described in Japanese Patent Application Laid-Open No. 2002-83563 (Patent Document 3), in addition to the above optical system, a reflecting plate made of metal is occasionally provided between a sample and a detector. As a result, secondary electrons generated from the surface of the sample are separated from reflected electrons, and they are captured by independent detectors. Shape information about the sample surface can be acquired based on the secondary electrons, and cubic information about sample unevenness can be acquired based on the reflected electrons. In this example, the applied voltage of the electrostatic lens controls the separation of the secondary electrons and the reflected electrons, and accelerates a charged particle beam passing through the objective lens so as to reduce chroma aberration generated on the objective lens.

In the astigmatism correcting unit of Japanese Patent Application Laid-Open No. 8-306331, the astigmatism is corrected by correction coefficients obtained in advance for the respective applied voltages of the electrostatic lens, so that an observation image without astigmatism can be obtained. An inductance of the astigmatism corrector, however, has time constant. For this reason, response time of the astigmatism corrector limits an effect of a high-speed focus correction of the electrostatic lens. Optical components such as a deflector, an objective lens and an electrostatic lens are provided on the side of the sample with respect to the astigmatism corrector. For this reason, chroma aberration and off-axis aberration which occur in the respective components cannot be eliminated. Therefore, resolution of the observation image has a problem.

In order to solve this problem, a means that an aberration correcting device is provided on a side closer to a sample with respect to the objective lens can be considered. In the optical system of Japanese Patent Application Laid-Open No. 2002-83563, since the electrostatic lens, the reflecting plate, the detector for detecting reflected electrons and the like are present near the objective lens, it is structurally difficult to provide the aberration corrector. When the aberration corrector is provided on the side closer to the sample with respect to the objective lens, a problem that a working distance becomes long arises.

### SUMMARY OF THE INVENTION

It is an object of the present invention to provide a charged particle beam device which is capable of correcting astigmatism, off-axis aberration and out-of-focus state simultaneously at high speed.

According to the charged particle beam device of the present invention, an electrostatic lens which generates an electric field on a trajectory of a charged particle beam is provided between an objective lens and a sample. The electrostatic lens is divided into a plurality of electrodes, and a voltage can be applied to the electrodes independently. When the voltage is adjusted, at least one of the astigmatism, the off-axis aberration and the out-of-focus state of the objective lens is corrected.

According to the present invention, the astigmatism, the off-axis aberration and the out-of-focus state can be corrected simultaneously at high speed.

### BRIEF DESCRIPTION OF THE DRAWINGS

FIG. 1 is diagram explaining one example of a structure of a scanning electronic microscope apparatus according to the present invention;

FIG. 2 is a diagram explaining one example of a horizontal section of an electrostatic lens according to the present invention;

FIGS. 3A to 3C are diagrams explaining a voltage applied to electrodes of the electrostatic lens and a shape of an electron beam at the time of correcting aberration according to the present invention;

FIG. 4 is a diagram illustrating a procedure example of a correcting method for aberration according to the present invention;

FIG. 5 is a diagram illustrating another procedure example of the correcting method for aberration according to the present invention;

FIG. 6 is a diagram explaining a method for correcting aberration manually by an operator according to the present invention; and

FIG. 7 is a diagram explaining an example of a screen of the electronic microscope apparatus for reviewing a semiconductor wafer defect according to the present invention.

### DESCRIPTION OF THE PREFERRED EMBODIMENTS

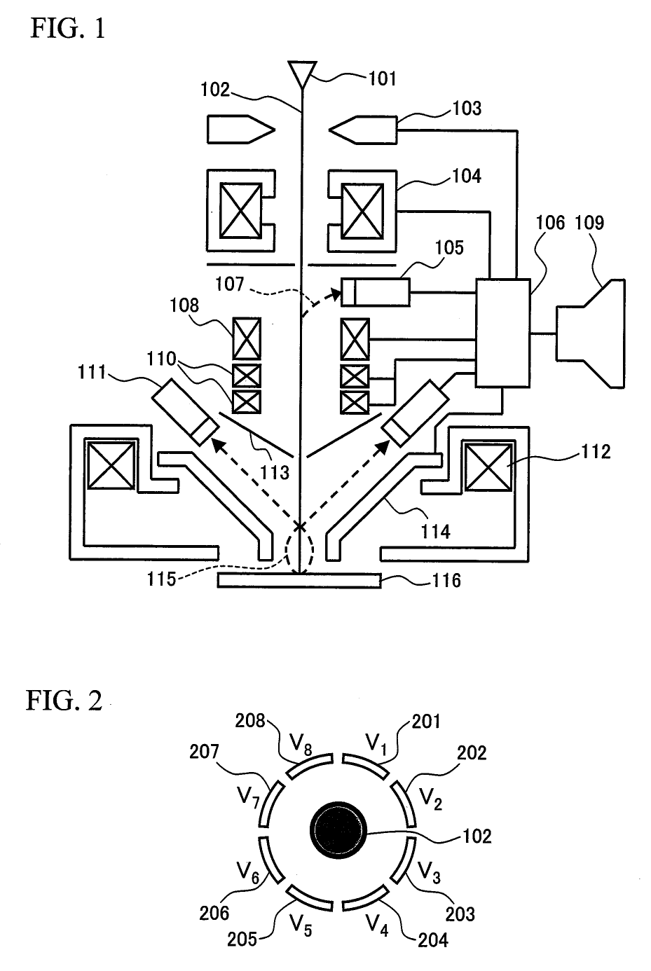

The present invention is described with reference to FIG. 1. A scanning electronic microscope apparatus of this example has an electron source (101), an extraction electrode (103), a condenser lens (104), a secondary electron detector (105), an alignment lens (108), deflecting lenses (110), a reflecting plate (113), a reflected electron detector (111), an objective lens (112), an electrostatic lens (114), a control section (106), and a display (109).

A voltage can be applied to the electrostatic lens (114) by control of the control section (106). When a voltage is applied to the electrostatic lens (114), an electric field is generated on a trajectory of an electron beam (102). Adjustment of the voltage applied to the electrostatic lens (114) provides a focus correcting function and an aberration correcting function.

In this example, the electrostatic lens (114) is constituted as a magnetic pole of the objective lens. That is to say, the electrostatic lens (114) composes a magnetic path of the objective lens, and a voltage can be applied thereto.

The electron beam (102) from the electron source (101) is extracted by the extraction electrode (103), and is converged by the condenser lens (104). Off-axis aberration of the electron beam (102) is corrected by the alignment lens (108), and the electron beam (102) is scanned two-dimensionally by the deflecting lens (110), is focused by the objective lens (112), and is emitted to a sample (116). A secondary electron (107) generated from the sample (116) and a reflected electron (115) from the sample (116) are separated by the reflecting plate (113). The secondary electron (107) whose energy is comparatively low and does not have a directional property is detected by the secondary electron detector (105). The reflected electron (115) whose energy is comparatively high and has a directional property is detected by the reflected electron detector (111).

Scintillator is used for electron detectors of the secondary electron detector (105) and the reflected electron detector (111). When a positive voltage is applied to the scintillator, the electron is attracted to the detector and is simultaneously accelerated, and collides with the scintillator. Light emission from the scintillator is amplified by a photoelectron multiplier, and the emitted light is transmitted to the control section (106) as a signal of the detector. In the control section (106), the signal of the detector is synchronized with a deflecting signal of the deflecting lens (110) so that a scanned image is displayed on the display (109).

When a positive voltage is applied to the electrostatic lens (114), an electric field is generated on a trajectory of the electron beam (102), and the secondary electron (107) generated from the sample (116) and the reflected electron (115) from the sample (116) are separated from each other. When a positive voltage is applied to the electrostatic lens (114), a positive electric field is generated, and a force, which pulls up the secondary electron (107) and the reflected electron (115) vertically, exerts. As a result, the secondary electron (107) passes through a hole on a center of the reflecting plate (113), and is attracted to the secondary electron detector (105) provided above it. The reflected electron (115) collides with the reflecting plate (113), and turns into a secondary electron (not shown) generated from the surface of the reflecting plate (113) so as to be attracted to the reflected electron detector (111).

The correction of the aberration in the scanning electronic microscope apparatus of this example is described. When a primary electron beam (102) shifts from a center axis line of the objective lens (112), an off-axis aberration occurs on the scanned image. Therefore, the alignment lens (108) is excited, the shift of the primary electron beam (102) is corrected so that the occurrence of the off-axis aberration is prevented.

When the positive voltage is applied to the electrostatic lens (114), the primary electron beam (102) is accelerated. As a result, the chroma aberration which occurs at the time when the primary electron beam (102) passes through the objective lens (112) is reduced. By adjusting the positive voltage applied to the electrostatic lens (114), the off-axis aberration, the astigmatism and the out-of-focus state are corrected as described below.

In this example, since the electrostatic lens (114) is used, inductance is not present unlike a magnetic field lens using a coil. For this reason, an element, which can operates at high speed, is used for controlling the voltage applied to the electrostatic lens, so that the off-axis aberration, the astigmatism and the out-of-focus state can be corrected at high speed.

In the scanning electronic microscope apparatus of this example, a memory device and an input device, not shown, are provided. Functions which show relationships among a value of the voltage applied to the electrostatic lens (114), the optical condition, and the off-axis aberration, the astigmatism and the out-of-focus state, are stored in the memory device. In order to obtain these functions, the operator changes the value of the voltage applied to the electrostatic lens (114) with respect to each image pick-up condition via the input device, so as to measure the off-axis aberration, the astigmatism and the out-of-focus state. In such a manner, the functions or the graphs of the off-axis aberration, the astigmatism and the out-of-focus state with respect to the value of the applied voltage are obtained.

When such functions or graphs are obtained, the operator uses the functions or the graphs at the time of observing the sample. When the image pickup condition is input, the control section (106) searches the memory device for the image pickup condition and reads the function corresponding to the image pickup condition. The value of the voltage applied to the electrostatic lens (114), by which the off-axis aberration, the astigmatism and the out-of-focus state become at a minimum, is read based on the function read. The correcting amount of the applied voltage is adjusted based on the data read.

The control section (106) can detect the off-axis aberration, the astigmatism and the out-of-focus state automatically from the image of the sample. The aberration and the out-of-focus state may be detected by using a well-known image process.

FIG. 2 illustrates an example of a section obtained by cutting the electrostatic lens (114) in a plane perpendicular to the primary electron beam (102) according to the present invention. In this example, the electrostatic lens (114) is divided into independent eight electrodes (201) to (208). The electrostatic lens (114) may be constituted by magnetic poles of the objective lens. In this case, an insulator may be inserted between the electrodes.

FIG. 2 illustrates the primary electron beam (102) without aberration as shown by a black circle. Therefore, the primary electron beam (102) passes through the center of the electrostatic lens (114), and has a circular section. The electrodes (201) to (208) are electrically insulated from each other, and different voltage can be applied to the respective electrodes. In this example, the voltages applied to the eight electrodes (201) to (208) are denoted by V₁, V₂, V₃, V₄, V₅, V₆, V₇ and V₈. As described below, the voltages are set to predetermined values, so that various aberrations of the primary electron beam (102) can be corrected.

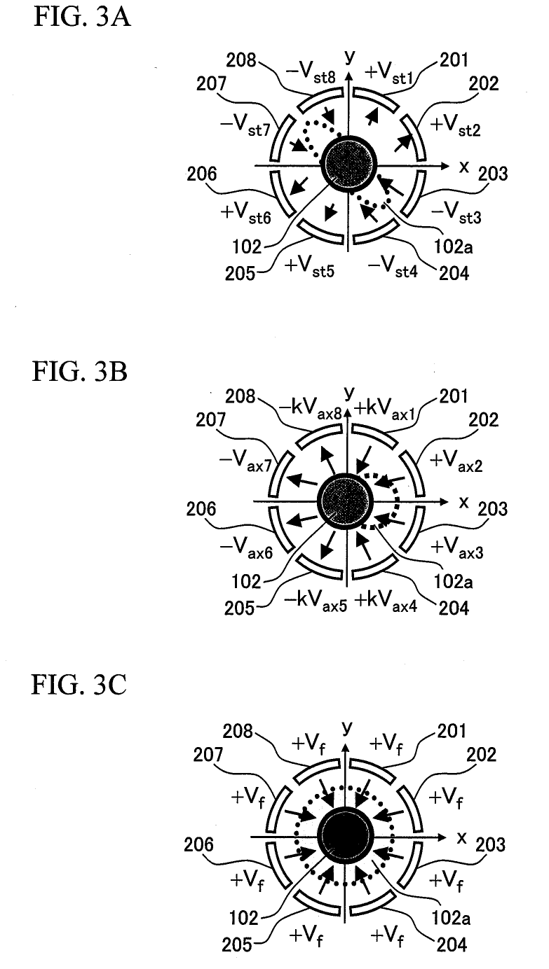

A method for correcting the aberrations of the primary electron beam (102) according to the present invention is described with reference to FIGS. 3A to 3C. As shown in FIGS. 3A to 3C, an x axis and a y axis are set on the plane which runs through the section of the electrostatic lens (114). Initial voltages of the electrodes (201) to (208) are denoted by vi (i is electrode number 1 to 8). The voltages applied to the electrodes (201) to (208) are expressed as sums of the initial voltages and the correcting amounts.

FIG. 3A illustrates an example that astigmatism of the primary electron beam (102) is corrected. The astigmatism is a state that the primary electron beam (102a) passes through the center of the electrostatic lens (114) and has an oval section as shown in the drawing. In order to eliminate the astigmatism, the section of the primary electron beam (102) may be deformed so as to be compressed in a direction along a long axis and to be pulled in a direction along a short axis. In order to obtain this state, the voltage applied in the direction along the long axis of the ellipse of the section of the primary electron beam (102) may be reduced and the voltage applied in the direction along the short axis of the ellipse may be increased. That is to say, the voltages applied to the third, fourth, seventh and eighth electrodes are reduced, and the voltages applied to the first, second, fifth and sixth electrodes are increased. In this example, the voltages V₁, V₂, V₃, V₄, V₅, V₆, V₇ and V₈ applied to the electrodes (201) to (208), respectively, are set to the following values.

V₁=v₁+Vₛₜ₁

V₂=v₂+Vₛₜ₂

V₃=v₃−Vₛₜ₃

V₄=v₄−Vₛₜ₄

V₅=v₅+Vₛₜ₅

V₆=v₆+Vₛₜ₆

V₇=v₇−Vₛₜ₇

V₈=v₈−Vₛₜ₈ Formula (1)

v₁ to v₈ of the first term on the right side of the formula (1) are the initial voltages, and Vₛₜ₁ to Vₛₜ₈ of the second term are the correcting amounts. As shown in the formula (1), the voltages V₃, V₄, V₇, V₈, applied in the direction along the long axis of the ellipse of the section of the primary electron beam (102) reduce, and the voltages V₁, V₂, V₅, V₆ applied in the direction along the short axis of the ellipse increase. As a result, the section of the primary electron beam (102) deforms so as to be compressed in the direction along the long axis and to be pulled in the direction along the short axis. In such a manner, the astigmatism of the primary electron beam (102a) is eliminated, and the primary electron beam (102a) passes through the center of the electrostatic lens (114) and has a circular section.

Even after the voltages are adjusted, the center position of the primary electron beam (102a) does not change. That is to say, the center position of the primary electron beam (102a) passes through the center of the electrostatic lens (114). In order to obtain this state, the correcting amounts of the three pairs of the electrodes whose paired electrodes are arranged on both sides of the long axis of the ellipse of the section of the primary electron beam (102) should be equal. For example, the first electrode (201) and the sixth electrode (206) are symmetrical with respect to the long axis of the ellipse. Therefore, the correcting amount Vₛₜ₁ of the voltage applied to the first electrode (201) and the correcting amount Vₛₜ₆ of the voltage applied to the sixth electrode (206) are equal to each other. Similarly, the second electrode (202) and the fifth electrode (205) are symmetrical with respect to the long axis of the ellipse. Therefore, the correcting amount Vₛₜ₂ of the voltage applied to the second electrode (202) and the correcting amount Vₛₜ₅ of the voltage applied to the fifth electrode (205) are equal to each other. Similarly, the third correcting amount Vₛₜ₃ and the fourth correcting amount Vₛₜ₄ are equal to each other, and the seventh correcting amount Vₛₜ₇ and the eighth correcting amount Vₛₜ₈ are equal to each other.

FIG. 3B illustrates an example that the off-axis aberration of the primary electron beam (102) is corrected. The off-axis aberration is a state that the primary electron beam (102a) passes through a position shifted from the center of the electrostatic lens (114) as shown in FIG. 3B and has a circular section. In order to eliminate the off-axis aberration, the primary electron beam (102) may be moved in a direction opposite to the shifting direction. In the example of the drawing, the primary electron beam (102a) shifts along the x-axial direction. Therefore, the primary electron beam (102a) is moved in the direction opposite to the shifting direction along the x-axial direction. In this example, the voltages applied to the electrodes on the right side with respect to the x axis are increased, and the voltages applied to the electrodes on the left side with respect to the x axis are reduced. As shown in FIG. 3B, the increase/decrease amounts of the voltages applied to the electrodes (202), (203), (206) and (207) near the x axis may be larger than the increase/decrease amount of the voltages applied to the electrodes (201), (204), (205) and (208) away from the x axis. In this example, the voltages V₁, V₂, V₃, V₄, V₅, V₆, V₇ and V₈ applied to the electrodes (201) to (208), respectively, are set to the following values.

V₁=v₁+kVₐₓ₁

V₂=v₂+Vₐₓ₂

V₃=v₃+Vₐₓ₃

V₄=v₄+kVₐₓ₄

V₅=v₅−k_{Vax5}

V₆=v₆−Vₐₓ₆

V₇=v₇−Vₐₓ₇

V₈=v₈−k_{Vax8} Formula (2)

v₁ to v₈ of the first term on the right side of the formula (2) are the initial voltages, and Vₐₓ₁ to Vₐₓ₈ of the second term are correcting amounts. k is a constant which is larger than 0 and smaller than 1. In this example, since the primary electron beam (102a) is moved along the x axial direction, the correcting amount of the voltages applied to the electrodes arranged above the x axis is equal to the correcting amount of the voltages applied to the electrodes arranged below the x axis. That is to say, the correcting amounts of the three pairs of the electrodes whose paired electrodes arranged on both sides of the x axis should be equal to each other. For example, the first electrode (201) and the fourth electrode (204) are symmetrical with respect to the x axis. Therefore, the correcting amount Vₛₜ₁ of the voltage applied to the first electrode (201) is equal to the correcting amount Vₛₜ₄ of the voltage applied to the fourth electrode (204). Similarly, the eighth electrode (202) and the fifth electrode (205) are symmetrical with respect to the x axis. Therefore, the correcting amount Vₛₜ₈ of the voltage applied to the eighth electrode (202) is equal to the correcting amount Vₛₜ₅ of the voltage applied to the fourth electrode (205).

Similarly, the second correcting amount Vₛₜ₂ is equal to the third correcting amount Vₛₜ₃, and the sixth correcting amount Vₛₜ₆ is equal to the seventh correcting amount Vₛₜ₇. If the correcting amounts of the voltages applied to the electrodes symmetrical with respect to the x axis are different from each other, the primary electron beam (102a) shifts to the y direction.

FIG. 3C illustrates an example that focus of the primary electron beam (102) is corrected. When the primary electron beam (102) is not brought to a focus, the section of the primary electron beam (102a) has a circular shape whose size is different from that of the section of the normal primary electron beam (102). The center of the primary electron beam (102) is at the center of the electrostatic lens (114), namely, the center does not shift. In order to eliminate the out-of-focus state of the primary electron beam (102), the dimension of the circular section of the primary electron beam (102) may be changed. In order to attain this state, the correcting amounts of the voltages applied to all the electrodes may be changed uniformly.

In this example, the voltages V₁, V₂, V₃, V₄, V₅, V₆, V₇ and V₈ applied to the electrodes (201) to (208), respectively, are set to the following values.

V₁=v₁+Vf

V₂=v₂+Vf

V₃=v₃+Vf

V₄=v₄+Vf

V₅=v₅+Vf

V₆=v₆+Vf

V₇=v₇+Vf

V₈=v₈+Vf Formula (3)

v₁ to v₈ of the first term on the right side of the formula (3) are the initial voltages, and Vf of the second term is the correcting amount. In order to enlarge the section of the primary electron beam (102a), the correcting amount Vf is set to a negative value, and in order to reduce the section of the primary electron beam (102a), the correcting amount Vf is set to a positive value.

As shown in the formulas (1) to (3), the correcting amount varies depending on which of the off-axis aberration, the astigmatism and the out-of-focus state is corrected. For example, the correcting amount by which the off-axis aberration becomes zero is not always equal to the correcting amount by which the astigmatism becomes zero. In general, the correcting amount, which simultaneously makes the off-axis aberration, the astigmatism and the out-of-focus state zero, does not exist. However, actually these aberrations simultaneously occur. In order to simultaneously correct the astigmatism, the off-axis aberration and the out-of-focus state, their correcting amounts may be added up. The voltages V₁, V₂, V₃, V₄, V₅, V₆, V₇ and V₈ applied to the electrodes (201) to (208), respectively, are set to the following values.

V₁=v₁+ΔV₁

V₂=v₂+ΔV₂

V₃=v₃+ΔV₃

V₄=v₄+ΔV₄

V₅=v₅+ΔV₅

V₆=v₆+ΔV₆

V₇=v₇+ΔV₇

V₈=v₈+ΔV₈ Formula (4)

ΔV₁ to ΔV₈ are the correcting amounts of the electrodes, by which the total sum of the off-axis aberration, the astigmatism and the out-of-focus state becomes minimum. The correcting amounts ΔV₁ to ΔV₈ may be the total sum of the correcting amount of the off-axis aberration, the correcting amount of the astigmatism and the correcting amount of the out-of-focus state. In the example of FIG. 3, the correcting amounts of the voltages applied to the electrodes are expressed by the following formula.

ΔV₁=+Vₛₜ₁+kVₐₓ₁+Vf

ΔV₂=+Vₛₜ₂+Vₐₓ₂+Vf

ΔV₃=−Vₛₜ₃+Vₐₓ₃+Vf

ΔV₄=−Vₛₜ₄+kVₐₓ₄+Vf

ΔV₅=+Vₛₜ₅−kVₐₓ₅+Vf

ΔV₆=+Vₛₜ₆−Vₐₓ₆+Vf

ΔV₇=−Vₛₜ₇−Vₐₓ₇+Vf

ΔV₈=−Vₛₜ₈−kVₐₓ₈+Vf Formula (5)

In this example, the correcting amounts of the voltages are expressed by a primary expression. Therefore, as shown in the formula (5), when a plurality of aberrations is corrected, the correcting amount is the sum of their respective correcting amounts. However, when the plurality of aberrations is corrected, the aberrations can be occasionally reduced by a high-order aberration correction. According to the present invention, when the plurality of aberrations is corrected, the high-order aberration correction may be made.

When the image pickup condition is changed, the initial voltages and the correcting amounts change. The correcting amounts change also according to the initial voltages. Therefore, the correcting amounts are also functions with respect to the image pickup condition and the initial voltages. The image pickup condition includes optical conditions such as voltages, magnifications and scanning conditions of the condenser lens (104), the deflecting lens (110), the objective lens (112) and the like.

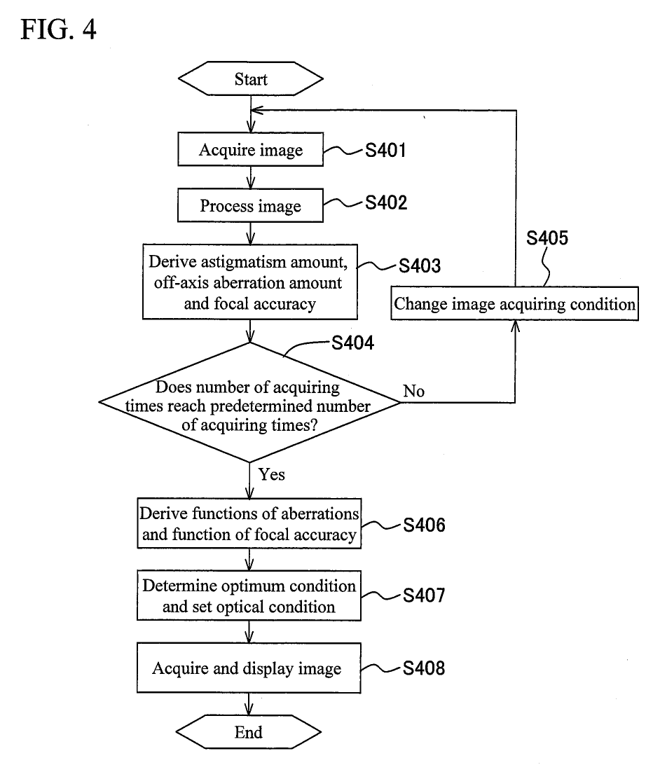

A procedure of the aberration correcting method according to the present invention is described with reference to FIG. 4. The image pickup condition is set, and the voltages applied to the electrodes of the electrostatic lens (114) are set to initial voltages so that an image is acquired at step S401. The acquired image is processed at step S402, and the astigmatism amount, the off-axis aberration amount and the focal accuracy are derived at step S403. A determination is made at step S404 whether the number of image acquiring times reaches a predetermined number of acquiring times. When the number of acquiring times does not reach the predetermined number of times, an image acquiring condition, namely, the correcting amounts of the voltages applied to the electrodes are changed at step S405, and an image is again acquired at step S401. This sequence is repeated, and when the number of image acquiring times reaches the predetermined number of times, the sequence goes to step S406 so that the correcting amounts of the voltages applied to the electrodes of the electrostatic lens (114), and the functions of the astigmatism amount, the off-axis aberration amount and the focal accuracy are obtained. The predetermined number of acquiring times is set to a number of times necessary for obtaining relationship between the voltage correcting amounts and the astigmatism amount, the off-axis aberration amount and the focal accuracy. These pieces of information are stored in the memory device. That is to say, the functions between the voltage correcting amounts and the astigmatism amount, the off-axis aberration amount and the focal accuracy, as well as the image pickup conditions are stored in the memory device.

The functions stored in the memory device are read, and the correcting amounts of the voltages applied to the electrodes are determined so that the astigmatism amount, the off-axis aberration amount and the focal accuracy each become optimum at step S407. That is to say, the correcting amounts of the voltages applied to the electrodes in the case where the astigmatism amount becomes minimum, the correcting amounts of the voltage applied to the electrodes in the case where the off-axis aberration amount becomes minimum, and the correcting amounts of the voltages applied to the electrodes in the case where the predetermined out-of-focus state becomes minimum are determined. As shown in the formula (5), the correcting amounts of the voltages applied to the electrodes of the electrostatic lens (114) in the case where the astigmatism amount, the off-axis aberration amount and the out-of-focus state simultaneously become minimum are determined. An image is acquired and is displayed on the display (109) at step S408.

When the functions are derived at steps S401 to S405, the image at the time of changing the correcting amounts of the voltages may be displayed on the display (109).

The aberration and the focus are corrected by adjusting the voltage of the electrostatic lens, but in this case, the methods in Japanese Patent Application Laid-Open No. 5-114378 and Japanese Patent Application Laid-Open No. 8-306331 can be used. Japanese Patent Application Laid-Open No. 5-114378 refers to the invention relating to the automatic focus correction by means of an exciting current of the objective lens, but the similar sequence can be applied to the voltage of the electrostatic lens.

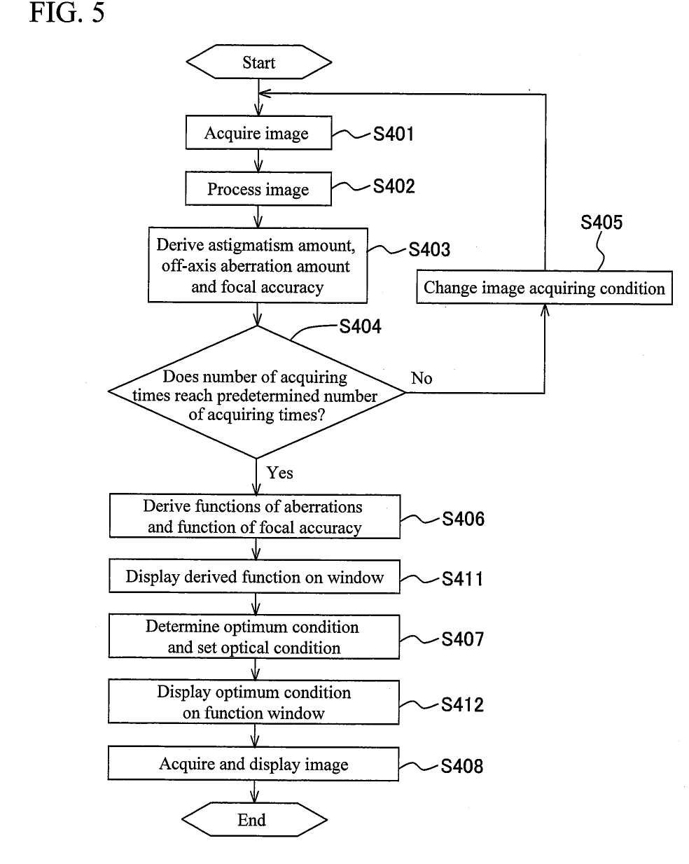

The procedure of another example of the aberration correcting method according to the present invention is described with reference to FIG. 5. The aberration correcting method in this example is different from the correcting method of FIG. 4 in that step S411 is inserted between the steps S406 and S407, and that step S412 is inserted between the steps S407 and S408. The functions derived at step S406 are displayed on the display (109) at step S411. In such a manner, the operator can understand the surface condition of the sample (116). Further, the relationships between the correcting amounts of the voltages applied to the electrodes determined at step S407 and the astigmatism amount, the off-axis aberration amount and the out-of-focus state are displayed on a function window on the display (109) at step S412. As a result, the operator can get an accuracy of the aberration correcting method, and can get information useful for changing the correcting amounts of the voltages applied to the electrodes.

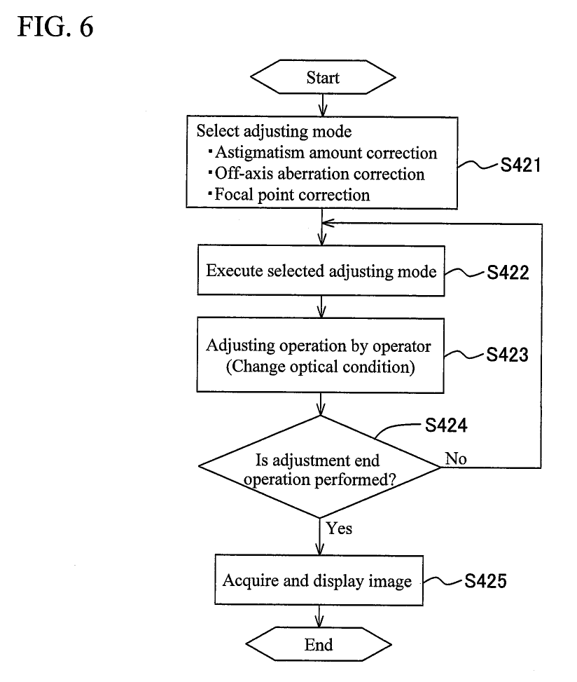

A method in which the operator makes various adjustments manually is described with reference to FIG. 6. An adjusting mode is selected by an operator's operation at step S421. The adjusting mode is any one of the astigmatism correction, the off-axis aberration correction and the focus correction. The selected adjusting mode is executed at step S422. The operator performs the adjusting operation, viewing the display (109) at step S423. The control section (106) determines whether the operator has performed an adjustment end operation. When the adjustment end operation is not performed, the sequence returns to step S422. This sequence is repeated, and when the adjustment end operation is performed, an image which reflects the adjusted result is acquired at step S425 so as to be displayed on the display (109).

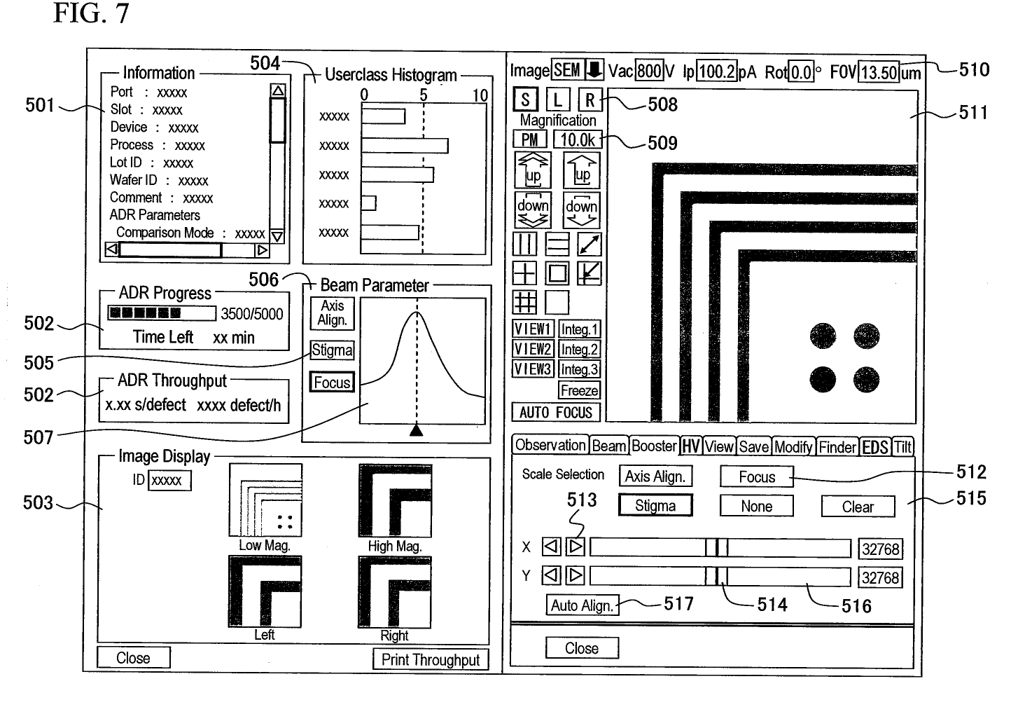

One example of the display screen of the display (109) in the scanning electronic microscope apparatus of the present invention is described with reference to FIG. 7. FIG. 7 illustrates an example of the screen in the electronic microscope apparatus for reviewing semiconductor wafer defect to which the present invention is applied. The screen is roughly composed of a review window on the left half portion and an electronic microscope operating screen on the right half portion.

The review window is described first. The review window includes an information portion (501), an ADR (AutoDefect Review) progress and ADR throughput portion (502), an image display portion (503), a userclass histogram portion (504) and a beam parameter portion (506). The information portion (501) shows a review condition. The ADR progress and ADR throughput portion (502) shows a progress, an operating speed and a residual time of a defect review operation. The image display portion (503) shows a low magnification image for defective alignment and respective images obtained by the optical system of Japanese Patent Application Laid-Open No. 2002-83563. The userclass histogram portion (504) shows the amounts according to defect classification. The beam parameter portion (506) is a function display window at steps S411 and S412 of FIG. 5.

The astigmatism function, the off-axis aberration function, the focal accuracy function can be displayed on the beam parameter portion (506) individually or simultaneously. The display/non-display is selected by clicking respective buttons (505) in the beam parameter portion (506) via a mouse of a PC (not shown) used for operator. The border of the clicked button is highlighted or is colored so that the operator is informed of the selected button. The selected function is displayed on the function window (507), and an optimum value is displayed by a dotted line in the window. The function displayed on the function window (507) is obtained at step S406.

The electronic microscope operating screen is described below. The electronic microscope operating screen includes a detector selecting portion (508), an image magnification display portion (509), an electron source (101) state display portion (510), an image display portion (511), and an optical condition operating portion (515). On the detector selecting portion (508), the secondary electron detector (105) provided to the optical system in Japanese Patent Application Laid-Open No. 2002-83563 or the right and left reflected electron detectors (111) is selected for an image to be displayed. The image display portion (511) shows the image of the detector selected on the detector selecting portion (508). The optical condition operating portion (515) provides a user interface for manually adjusting the optical condition by the operator.

Alphabets which represent their respective detectors are displayed on the detector selecting portion (508). S is the secondary electron detector (105), L is the reflected electron detector (111) on the left side, and R is the reflected electron detector (111) on the right side. The selection of the detector to be used for displaying on the image display portion (511) and the displaying of the selected button are similar to the buttons (505) on the beam parameter window.

Tags showing groups' names in which the optical conditions to be operated are classified are provided to the optical condition operating portion (515). When the items in the respective tags are operated, the optical conditions can be adjusted manually.

As one example, a case where the voltages of the electrostatic lens (Booster tag) is described. The booster tag is provided with selection buttons (512) of the adjusting contents, and they are a button (Axis Align.) for adjusting the off-axis aberration, a button (Stigma) for adjusting the astigmatism and a button (Focus) for adjusting the focus. A process for displaying the selected button is similar to the detector selecting portion (508). When the operator selects the adjusting content, parameter correcting bars (516) on a lower portion are associated with control values of the applied voltage to the electrostatic lens (114). When in this state, an increase/decrease button X/Y (513) is clicked, or adjustment bars (514) are pulled so as to be moved right and left, biaxial manual adjustment can be carried out. When the Auto Align. button (517) is pushed down, automatic adjustment sequence is carried out arbitrarily by the operator so that the optimum optical conditions can be obtained.

One example of the display screen on the display (109) is described, but the arrangement of the window and the method for displaying selected items using the buttons and bars in the above description do not restrict another method. For example, the arrangement of the window can be changed arbitrarily by the operator. Instead that the border of the button is highlighted, the selected item can be displayed by use of a pull-down menu and a radio button.

The present invention can be utilized in scanning microscopes, electron beam drawing devices, ion beam devices and similar devices using the scanning charged particle beams, which observe and machine living things, materials, semiconductor integrated circuits and the like.

The examples of the present invention are described above, but the present invention is not limited to the above examples, and a person skilled in the art easily understands that various modifications may be made without departing from the scope of the invention.

### DESCRIPTION OF LETTERS OR NUMERALS

101: electron source
102: electron beam
103: extraction electrode
104: condenser lens
105: secondary electron detector
106: control section
107: secondary electron
108: alignment lens
109: display
110: deflecting lens
111: reflected electron detector
112: objective lens
113: reflecting plate
114: electrostatic lens
115: reflected electron
116: sample
201: electrode
501: information portion
502: ADR throughput portion
503: image display portion
504: userclass histogram portion
505: button
506: beam parameter portion
507: function window
508: detector selecting portion
509: magnification display portion
510: electron source state display portion
511: image display portion
512: adjusting contents selection button
513: increase/decrease button
514: adjustment bar
515: optical condition operating portion
516: parameter correcting bar
517: Auto Align. button

What is claimed is:

1. A charged particle beam device comprising:
an irradiating lens which irradiates a sample with a charged particle beam;
a deflecting lens which scans the charged particle beam;
a detector which detects both a secondary particle generated from the sample and a reflected particle from the sample;
an objective lens which converges the charged particle beam; and
an electrostatic lens which generates an electric field on a trajectory of the charged particle beam,
wherein said electrostatic lens includes a plurality of electrodes, and voltages applied to said plurality of electrodes are controlled independently.

2. The charged particle beam device according to claim 1, wherein said electrostatic lens comprises a magnetic pole of said objective lens.

3. The charged particle beam device according to claim 1, wherein, by adjusting values of said applied voltages, at least one of off-axis aberration, astigmatism and out-of-focus state of said charged particle beam is corrected.

4. The charged particle beam device according to claim 1, wherein said applied voltages are expressed as a sum of initial voltages and correcting amounts, and the correcting amounts are increased or decreased so that the applied voltages are adjusted.

5. The charged particle beam device according to claim 1, wherein a memory device which stores functions between the values of said applied voltages and the off-axis aberration, the astigmatism and the out-of-focus state of said charged particle beam is provided, and when an image pickup condition of the sample is given, the voltages applied to said plurality of electrodes are obtained based on the functions stored in said memory device so that at least one of the off-axis aberration, the astigmatism and the out-of-focus state of said charged particle beam becomes minimum.

6. The charged particle beam device according to claim 5, wherein a display device which displays an image of the sample is provided, and a screen having a field for inputting the image pickup condition and a field for displaying a graph of said function under the image pickup condition is displayed on the display device.

7. The charged particle beam device according to claim 5, wherein buttons or slide bars for changing the values of said applied voltages in order to minimize the off-axis aberration, the astigmatism or the out-of-focus state of said charged particle beam, are displayed on the screen displayed on the display device.

8. A scanning electronic microscope apparatus comprising:
an irradiating lens which irradiates a sample with an electron beam;
a deflecting lens which scans the electron beam;
a detector which detects a secondary electron generated from the sample and a reflected electron from the sample;
an objective lens which converges the electron beam;
an electrostatic lens which is arranged between said objective lens and the sample and generates an electric field on a trajectory of the electron beam;
a display device which displays an image of said sample;
an input device which inputs a command from an operator;
a memory device which stores data for controlling said lens; and
a control device which adjusts a voltage of said lens,
wherein said electrostatic lens includes a plurality of electrodes, and said control device adjusts values of voltages applied to said plurality of electrodes, so as to correct at least one of off-axis aberration, astigmatism and out-of-focus state.

9. The scanning electronic microscope apparatus according to claim 8, wherein said electrostatic lens comprises a magnetic pole of said objective lens.

10. The scanning electronic microscope apparatus according to claim 8, wherein said applied voltages are expressed as a sum of an initial voltage and a correcting amount, and the correcting amount is increased or decreased so that the applied voltages are adjusted.

11. The scanning electronic microscope apparatus according to claim 8, wherein said memory device stores functions between values of said applied voltages and the off-axis aberration, the astigmatism and the out-of-focus state of said charged particle beam, and when an image pickup condition is given via said input device, said control device reads the values of the voltages applied to said plurality of electrodes from the functions stored in said memory device so that at least one of the off-axis aberration, the astigmatism and the out-of-focus state of said charged particle beam becomes minimum.

12. The scanning electronic microscope apparatus according to claim 8, wherein when the values of the voltages applied to said plurality of electrodes are changed, said control device detects at least one of the off-axis aberration, the astigmatism and the out-of-focus state from the image of said sample so as to derive a function showing a relationship between the values of the voltages applied to said plurality of electrode and at least one of the off-axis aberration and the astigmatism and the out-of-focus state and to store the function in said memory device.

13. The scanning electronic microscope apparatus according to claim 12, wherein said control device detects at least one of the off-axis aberration, the astigmatism and the out-of-focus state from the image of said sample by means of image processing.

14. The scanning electronic microscope apparatus according to claim 8, wherein said display device displays a screen showing at least one of the off-axis aberration, the astigmatism and the out-of-focus state and the values of the voltages applied to said plurality of electrodes as well as the image of the sample.

15. The scanning electronic microscope apparatus according to claim 14, wherein the screen displayed on the display device has tab type windows for adjusting the off-axis aberration, the astigmatism and the out-of-focus state, and the operator can select the window for correcting the off-axis aberration in order to correct the off-axis aberration, select the window for correcting the astigmatism in order to correct the astigmatism, and select the window for correcting the out-of-focus state in order to correct the out-of-focus state.

16. The scanning electronic microscope apparatus according to claim 15, wherein buttons or bars for correction are displayed on the respective windows, and the operator operates the buttons or the bars so as to adjust the values of the voltages applied to said plurality of electrodes.

17. A control method for scanning electronic microscope apparatus, comprising:
a step of irradiating a sample with an electron beam by means of an irradiating lens;
a step of scanning the electron beam by means of a deflecting lens;
a step of detecting a secondary electron generated from the sample and a reflected electron from the sample;
a step of converging the electron beam by means of an objective lens;
a step of generating an electric field on a trajectory of the electron beam by means of an electrostatic lens which is arranged between said objective lens and the sample and includes a plurality of electrodes; and
a step of controlling voltages applied to the plurality of electrodes of said electrostatic lens independently so as to correct at least one of off-axis aberration, astigmatism and out-of-focus state of a charged particle beam.

18. The control method for scanning electronic microscope apparatus according to claim 17, wherein said electrostatic lens comprises a magnetic pole of said objective lens.

19. The control method for scanning electronic microscope apparatus according to claim 17, further comprising:
a step of obtaining functions expressing relationships between values of voltages applied to said plurality of electrodes and said off-axis aberration, said astigmatism and said out-of-focus state,
wherein at said correcting step, when an image pickup condition is given, the values of the voltages applied to the plurality of electrodes of said electrostatic lens are obtained based on the functions.

20. The control method for scanning electronic microscope apparatus according to claim 17, further comprising:
a step of displaying a screen having tab type windows for adjusting the off-axis aberration, the astigmatism and the out-of-focus state on a display device,
wherein an operator can select the window for correcting the off-axis aberration in order to correct the off-axis aberration, select the window for correcting the astigmatism in order to correct the astigmatism, and select the window for correcting the out-of-focus state in order to correct the out-of-focus state.
